(19) United States
(12) Patent Application Publication
(10) Pub. No.: US 2024/0134674 A1
(43) Pub. Date: Apr. 25, 2024

(54) INFORMATION PROCESSING DEVICE, VEHICLE, INFORMATION PROCESSING METHOD, AND RECORDING MEDIUM ON WHICH A PROGRAM IS RECORDED

(71) Applicant: TOYOTA JIDOSHA KABUSHIKI KAISHA, Toyota-shi (JP)

(72) Inventor: Taiki MIZUTANI, Miyoshi-shi (JP)

(73) Assignee: TOYOTA JIDOSHA KABUSHIKI KAISHA, Toyota-shi (JP)

(21) Appl. No.: 18/242,730

(22) Filed: Sep. 5, 2023

(30) Foreign Application Priority Data
Oct. 20, 2022 (JP) 2022-169438

(51) Int. Cl. G06F 9/455

(52) U.S. Cl. CPC G06F 9/45558; G06F 2009/45562; G06F 2009/45575; G06F 2009/45583

(57) ABSTRACT

An information processing device has: a generating section generating plural virtual machines including a managing virtual machine that manages the plural virtual machines; a non-volatile memory storing, for each of the plural virtual machines, data needed to activate the virtual machine; and a volatile memory. At a time when the managing virtual machine is activated, the managing virtual machine reads-out the respective data of the plural virtual machines from the non-volatile memory and stores the data in the volatile memory. At a time when each virtual machine of the plural virtual machines is activated, the virtual machine reads-out the data of the virtual machine from the volatile memory.

### CROSS-REFERENCE TO RELATED APPLICATION

This application is based on and claims priority under 35 USC 119 from Japanese Patent Application No. 2022-169438 filed on Oct. 21, 2022, the disclosure of which is incorporated by reference herein.

### BACKGROUND

### Technical Field

The present disclosure relates to an information processing device, a vehicle, an information processing method, and a recording medium on which a program is recorded, which can be applied to a vehicle onboard system.

### Related Art

Japanese Patent Application Laid-Open (JP-A) No. 2013-8322 proposes a virtualization system that activates plural virtual machines at the same time. In detail, the virtualization system includes a virtualization managing device and virtualization devices. On the basis of system structure information in which activation times and end times are set in correspondence with one another for each of plural virtual machines, the virtualization managing device generates, for each of the plural virtual machines, schedule information in which a transmitting time, at which a virtual machine image corresponding to the virtual machine is transmitted from a storage device to the virtualization device, is set in correspondence with that virtual machine such that the transmitting times of the plural virtual machines do not overlap. In accordance with the transmitting time, which is included in the schedule information and corresponds to the virtual machine that is activated on a hardware resource of the virtualization device, the virtualization device acquires the virtual machine image stored in the storage device, and activates the virtual machine on the basis of the virtual machine image at the activation time included in the schedule information.

In a system having plural virtual machines such as a vehicle onboard system, reading-out from a non-volatile memory is executed at times when the respective virtual machines are activated, and therefore, competition for access arises.

### SUMMARY

The present disclosure was developed in consideration of the above-described circumstances, and an object thereof is to provide an information processing device, a vehicle, an information processing method, and an information processing program that can reduce times required to activate plural virtual machines at times of activating the respective virtual machines.

A first aspect is an information processing device including: a generating section generating plural virtual machines including a managing virtual machine that manages the plural virtual machines; a non-volatile memory storing, for each of the plural virtual machines, data needed to activate the virtual machine; and a volatile memory, wherein, at a time when the managing virtual machine is activated, the managing virtual machine reads-out the respective data of the plural virtual machines from the non-volatile memory and stores the data in the volatile memory, and, at a time when each virtual machine of the plural virtual machines is activated, the virtual machine reads-out the data of the virtual machine from the volatile memory.

In accordance with the information processing device of the first aspect, the generating section generates the plural virtual machines that include the managing virtual machine that manages the plural virtual machines. Here, “manages the plural virtual machines” means managing the operations of the plural virtual machines that are other than the managing virtual machine. Further, “data needed to activate the virtual machine” is, for example, data used in initializing the virtual machine. When the managing virtual machine is activated, the managing virtual machine reads-out the respective data of the plural virtual machines from the non-volatile memory and stores the data in the volatile memory. Then, when each of the plural virtual machines is activated, the virtual machine reads-out the data of the virtual machine from the volatile memory.

In this way, when each of the plural virtual machines other than the managing virtual machine is activated, the data needed to activate the virtual machine is read-out from the volatile memory and not from the non-volatile memory. Accordingly, at the time of activating each of the plural virtual machines, the time required to activate each virtual machine can be reduced.

In an information processing device of a second aspect, in the information processing device of the first aspect, the managing virtual machine reads-out the data of the virtual machines from the non-volatile memory and stores the data in the volatile memory, in an order corresponding to preset priority levels of the respective virtual machines.

In accordance with the information processing device of the second aspect, the managing virtual machine reads-out the data of the virtual machines from the non-volatile memory and stores the data in the volatile memory, in an order corresponding to preset priority levels of the respective virtual machines. Due thereto, the necessary data can be stored in the volatile memory in accordance with the priority levels of the respective virtual machines. Accordingly, the data of the virtual machines can be read-out from the non-volatile memory and stored in the volatile memory in the order in which the virtual machines are to be activated.

In an information processing device of a third aspect, in the information processing device of the first aspect, the managing virtual machine is activated first among the plural virtual machines.

In accordance with the information processing device of the third aspect, the managing virtual machine is activated first among the plural virtual machines, and the managing virtual machine reads-out the respective data of the plural virtual machines from the non-volatile memory and stores the data in the volatile memory. Due thereto, even if the respective virtual machines that are other than the managing virtual machine are activated in parallel, the time required for activation can be reduced.

A fourth aspect is a vehicle that includes the information processing device of any one of the first through third aspects.

In accordance with the vehicle of the fourth aspect, the generating section generates the plural virtual machines that include the managing virtual machine that manages the plural virtual machines. When the managing virtual machine is activated, the managing virtual machine reads-out the respective data of the plural virtual machines from the non-volatile memory and stores the data in the volatile memory. Then, when each of the plural virtual machines is activated, the virtual machine reads-out the data of the virtual machine from the volatile memory. Accordingly, at the time of activating each of the plural virtual machines, the time required to activate each virtual machine can be reduced.

A fifth aspect is an information processing method in an information processing device that has a non-volatile memory storing, for each of plural virtual machines including a managing virtual machine that manages the plural virtual machines, data needed to activate the virtual machine, and a volatile memory, the method including: generating the plural virtual machines; at a time when the managing virtual machine is activated, reading-out the respective data of the plural virtual machines from the non-volatile memory and storing the data in the volatile memory; and, at a time when each virtual machine of the plural virtual machines is activated, reading-out the data of the virtual machine from the volatile memory.

In accordance with the information processing method of the fifth aspect, the information processing device generates the plural virtual machines. When the managing virtual machine is activated, the managing virtual machine reads-out the respective data of the plural virtual machines from the non-volatile memory and stores the data in the volatile memory. When each of the plural virtual machines is activated, the virtual machine reads-out the data of the virtual machine from the volatile memory. Accordingly, at the time of activating each of the plural virtual machines, the time required to activate each virtual machine can be reduced.

A sixth aspect is a non-transitory recording medium on which is recorded a program executable by a computer to perform processing, the computer including a non-volatile memory storing, for each of plural virtual machines including a managing virtual machine that manages the plural virtual machines, data needed to activate the virtual machine, and a volatile memory, the processing comprising: generating the plural virtual machines; at a time when the managing virtual machine is activated, reading-out the respective data of the plural virtual machines from the non-volatile memory and storing the data in the volatile memory; and, at a time when each virtual machine of the plural virtual machines is activated, reading-out the data of the virtual machine from the volatile memory.

In accordance with the program recorded on the non-transitory recording medium of the sixth aspect, the computer generates the plural virtual machines. When the managing virtual machine is activated, the managing virtual machine reads-out the respective data of the plural virtual machines from the non-volatile memory and stores the data in the volatile memory. When each of the plural virtual machines is activated, the virtual machine reads-out the data of the virtual machine from the volatile memory. Accordingly, at the time of activating each of the plural virtual machines, the time required to activate each virtual machine can be reduced.

In accordance with the present disclosure, when activating plural virtual machines respectively, the times required to activate the respective virtual machines can be reduced.

### BRIEF DESCRIPTION OF THE DRAWINGS

Exemplary embodiments of the present disclosure will be described in detail based on the following figures, wherein:

FIG. 1 is a drawing illustrating a vehicle in which a central ECU relating to a present embodiment is installed;

FIG. 2 is a block drawing illustrating hardware structures of the central ECU relating to the present embodiment, and is a block drawing illustrating the schematic structure.

FIG. 3 is a block drawing illustrating the schematic structure of the central ECU relating to the present embodiment;

FIG. 4 is a functional block drawing illustrating functions of a hypervisor;

FIG. 5 is a drawing illustrating an example of the structure of storage regions on a RAM;

FIG. 6 is a drawing illustrating an example of the structure of regions shared on the RAM;

FIG. 7 is a flowchart illustrating an example of the flow of processing at the time of activating a managing VM that is carried out at the central ECU relating to the present embodiment;

FIG. 8 is a flowchart illustrating an example of the flow of processing at the time of activating a VM that is carried out at the central ECU relating to the present embodiment;

FIG. 9 is a drawing illustrating an example of an activation sequence carried out at the central ECU relating to the present embodiment; and

FIG. 10 is a drawing illustrating an example of an activation sequence in a conventional technique.

### DETAILED DESCRIPTION

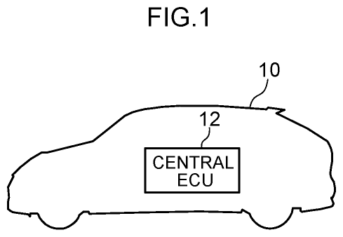

An example of an embodiment of the present disclosure is described in detail hereinafter with reference to the drawings. In the present embodiment, a central ECU (Electronic Control Unit) that is installed in a vehicle is described as an example of the information processing device. In the present embodiment, FIG. 1 is a drawing illustrating a vehicle in which the central ECU relating to the present embodiment is installed.

A central ECU 12 relating to the present embodiment is installed in a vehicle 10, and integrally controls various ECUs that are provided in the vehicle 10.

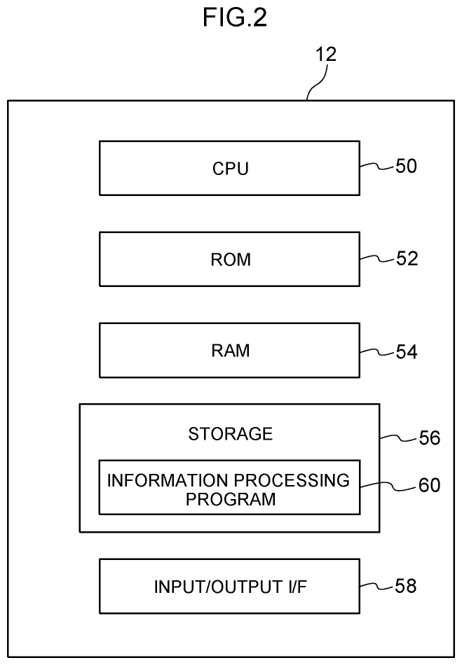

As illustrated in FIG. 2, the central ECU 12 is structured to include a CPU (Central Processing Unit) 50, a ROM (Read Only Memory) 52, a RAM (Random Access Memory) 54, a storage 56, and an input/output OF (InterFace) 58. The CPU 50, the ROM 52, the RAM 54, the storage 56 and the input/output OF 58 are connected so as to be able to communicate with one another via an unillustrated internal bus.

The CPU 50 is a central computing processing unit, and executes various programs and controls respective sections. Namely, the CPU 50 reads-out programs from the ROM 52 or the storage 56, and executes the programs by using the RAM 54 as a workspace. The CPU 50 is an example of the processor, the RAM 54 is an example of the volatile memory, and the storage 56 is an example of the non-volatile memory.

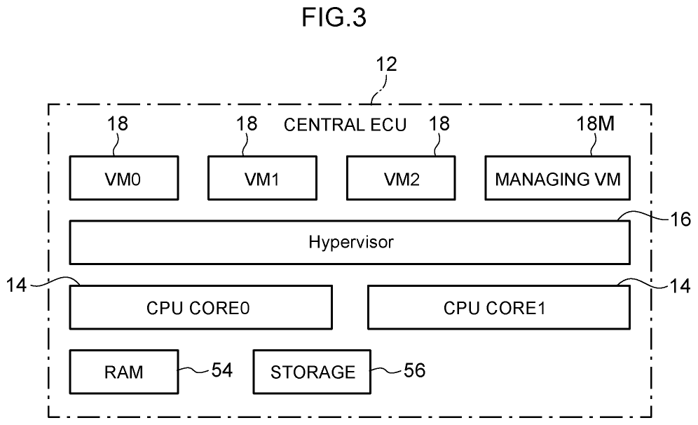

In the present embodiment, as an example, there are plural CPU cores 14 as illustrated in FIG. 3. (In the example of FIG. 3, there are two CPU cores that are CPU CORE 0 and CPU CORE 1.)

The ROM 52 stores various programs and various data. The RAM 54 temporarily stores programs and data as a workspace.

The storage 56 stores various programs and various data. An information processing program 60 is stored in the storage 56 of the present embodiment.

The storage 56 is structured by, for example, an HDD (Hard Disk Drive) or an SSD (Solid State Drive).

The input/output I/F 58 is an interface for communicating with respective other ECUs (not illustrated).

FIG. 3 is a block drawing illustrating the schematic structure of the central ECU 12 relating to the present embodiment.

In the present embodiment, the plural CPU cores 14 are virtualized, and VMs (Virtual Machines) 18 that serve as the virtual machines are generated, by a hypervisor 16 that is software for virtualizing a computer. In the present embodiment, the plural VMs 18 are generated by the hypervisor 16. FIG. 3 illustrates an example in which three VMs 18 which are VM0 through VM2, and a managing VM 18M, are generated as the plural VMs 18. For example, the plural VMs 18 include a multimedia VM, a body control VM, an engine control VM, and an autonomous driving control VM.

By the way, in a system using a general hypervisor, verification and program loading are carried out per VM, and initialization is executed per VM. At this time, dispersion arises also in the initialization times at the respective VMs due to the fact that the load times are different. Because system initialization is completed at the point in time when the initializations of all of the VMs are completed, it is preferable for the initialization time of the VM, whose initialization is the slowest, to be earlier.

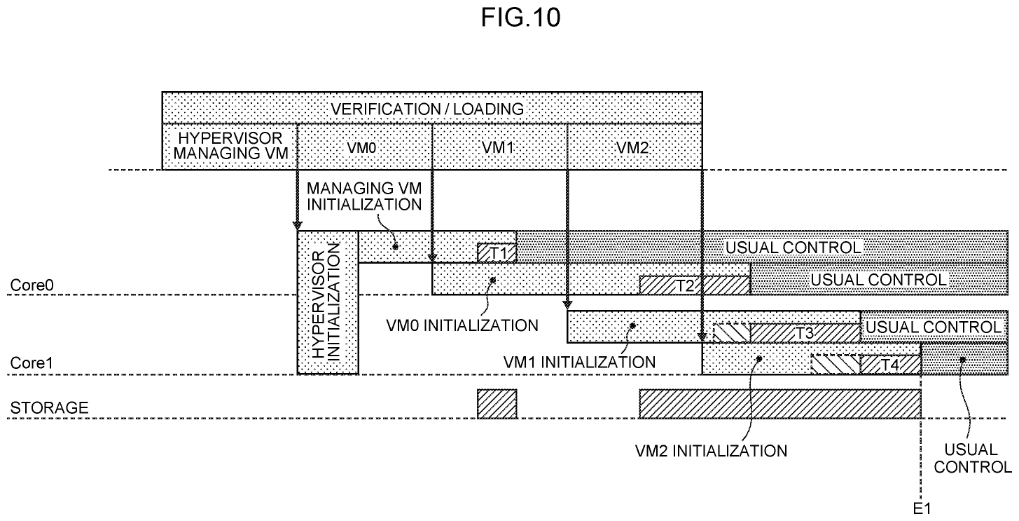

In conventional techniques, as in the activation sequence shown in FIG. 10 for example, verification and loading of the program are carried out for each VM, and the initializations are carried out in parallel. However, because the accessing of the storage that is a non-volatile memory is not carried out in parallel, a bottleneck may arise at the time of initialization. The hatched regions in FIG. 10 are time periods in which the storage is being accessed.

In the example in FIG. 10, because the programs of the respective VMs are loaded successively, there is dispersion in time periods T1 through T4 of reading-out from the storage in the initialization. Due thereto, in the initialization phase, access cannot be carried out efficiently such as there are times when the storage is not being accessed arise, or conversely, there are times when the storage is accessed overlappingly and wait times arise, or the like, and initialization completion time E1 is delayed. Accordingly, delay in the activation time, deterioration in the responsiveness of accessing the storage in usual control, and delays in the initialization of other cores in a multicore system may arise.

Thus, at the central ECU 12 relating to the present embodiment, due to the managing VM 18M first reading-out, from the storage 56, the data that is needed at the time of initializing the other VMs 18, the managing VM 18M realizes efficient reading-out from the storage 56.

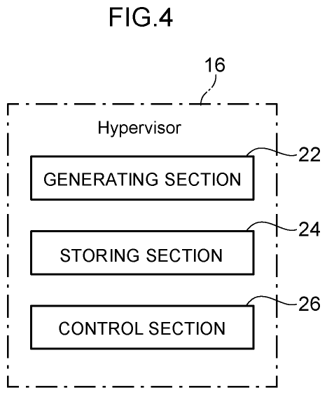

Functional structures of the hypervisor 16 are described here. FIG. 4 is a functional block drawing illustrating the functions of the hypervisor 16.

As illustrated in FIG. 4, the hypervisor 16 has the functions of a generating section 22, a storing section 24 and a control section 26.

The generating section 22 carries out generation of the plural VMs 18 that virtualize the CPU cores 14. In the present embodiment, as described above, the three VMs 18 that are VM0 through VM2, and the managing VM 18M are generated.

The storing section 24 stores the data needed for activation of the VM 18, for each of the plural VMs 18 and the managing VM 18M.

Specifically, the storing section 24 stores the data that is read-out at the time of executing initialization in the activation of the VM 18, for each of the plural VMs 18 and the managing VM 18M.

The control section 26 activates the plural VMs 18 that are generated. At this time, the control section 26 activates the managing VM 18M first among the plural VMs 18.

When the managing VM 18M is activated, the managing VM 18M reads-out the respective data of the plural VMs 18 from the storage 56 and stores the data in the RAM 54. Further, at the time when each of the plural VMs 18 is activated, the VM 18 reads-out the data of that VM 18 from the RAM 54, and carries out initialization.

The managing VM 18M reads-out the data of the plural VMs 18 from the storage 56 and stores the data in the RAM 54, in an order corresponding to predetermined priority levels of the respective VMs 18. For example, the priority levels are set in the order of VM0, VM1, VM2, and the data of the plural VMs 18 are read-out from the storage 56 and are stored in the RAM 54 in the order of VM0, VM1, VM2.

Here, the managing VM 18M is set so as to be able to access the storage 56. Further, the respective data of the plural VMs 18 that are read-out by proxy, and the storage areas on the RAM 54 after reading-out, are set at the managing VM 18M. Each VM 18 holds information that expresses the storage area on the RAM 54 of the data of that VM 18 that the managing VM 18M read-out by proxy. Namely, a region that can share the respective data of the plural VMs 18 that were read-out by the managing VM 18M is ensured on the RAM 54.

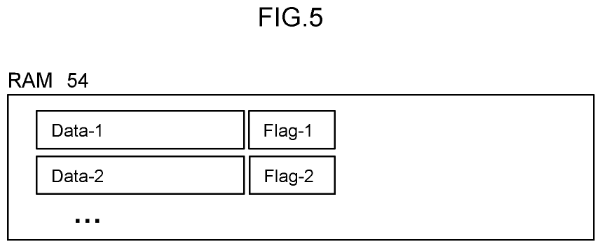

Specifically, as illustrated in FIG. 5, the RAM 54 has regions Data-1, Data-2, . . . in which the data read-out from the storage 56 by the managing VM 18M are placed, and flags Flag-1, Flag-2, . . . for judging whether or not the reading-out of data of the VM 18 from the storage 56 has been completed. For example, the flags Flag-1, Flag-2, . . . are set to “1” if reading-out has been completed.

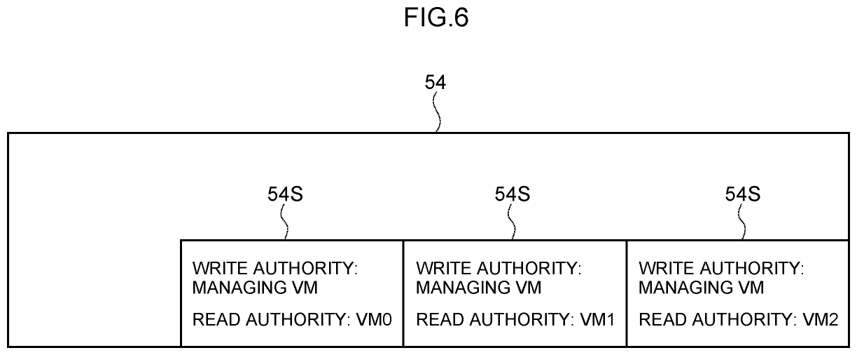

Further, as illustrated in FIG. 6, regions 54S that share the data on the RAM 54 are set so as to provide a write authority to the managing VM 18M and read authorities to the VMs 18. In the example of FIG. 6, the regions 54S are set for VM0, VM1, VM2, respectively.

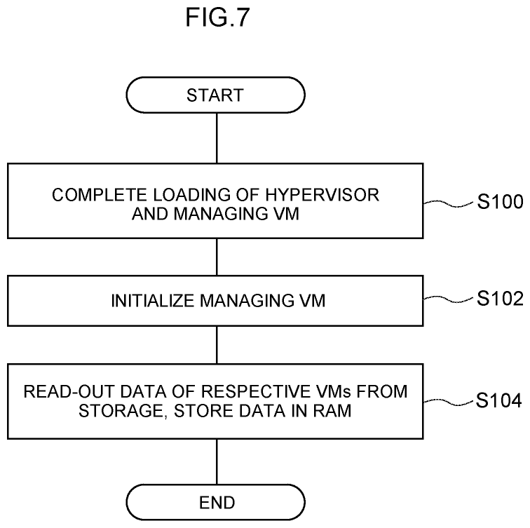

The specific processing, which is carried out at the central ECU 12 relating to the present embodiment that is structured as described above, is described next. FIG. 7 is a flowchart showing an example of the flow of processing at the time of activating the managing VM 18M, which processing is carried out at the central ECU 12 relating to the present embodiment. Note that the processing of FIG. 7 starts in a case in which unlocking of the doors (not illustrated) of the vehicle 10 is carried out.

In step S100, the CPU 22 completes the verification of and the loading of the programs of the hypervisor 16 and the managing VM 18M. Further, the CPU 22 carries out initialization of the hypervisor 16.

In step S102, as the hypervisor 16, the CPU 22 carries out initialization of the managing VM 18M. At this time, the CPU 22 reads-out the data of the managing VM 18M from the storage 56, and carries out initialization of the managing VM 18M.

In step S104, as the managing VM 18M, the CPU 22 reads-out the respective data of the plural VMs 18 from the storage 56 and stores the data in the RAM 54, and ends the series of processings.

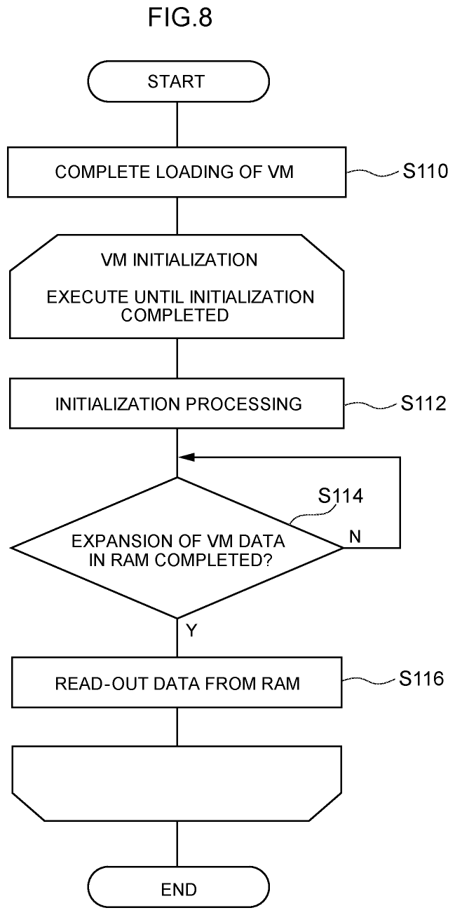

FIG. 8 is a flowchart illustrating an example of the flow of the processing at the time of activating the respective VMs 18, which processing is carried out at the central ECU 12 relating to the present embodiment. The processing shown in FIG. 8 is repeatedly executed as the VM 18 that is the object, for the plural VMs 18 successively.

In step S110, the CPU 22 completes verification of and loading of the program of the object VM 18.

Next, steps S112 through S116 are repeated until the initialization of the object VM 18 is completed.

In step S112, as the hypervisor 16, the CPU 22 carries out initialization processing of the object VM 18. At this time, initialization of the object VM 18 is carried out by using the data of the object VM 18, which data was read-out in step S116 of the previous time.

In step S114, as the hypervisor 16, the CPU 22 judges whether or not expansion of the data of the object VM 18 has been completed in the RAM 54. If expansion of the data of the object VM 18 has been completed in the RAM 54, the CPU 22 moves on to step S116.

In step S116, as the hypervisor 16, the CPU 22 reads-out the data of the object VM 18 from the RAM 54.

When initialization of the object VM 18 is completed, the series of processings is ended.

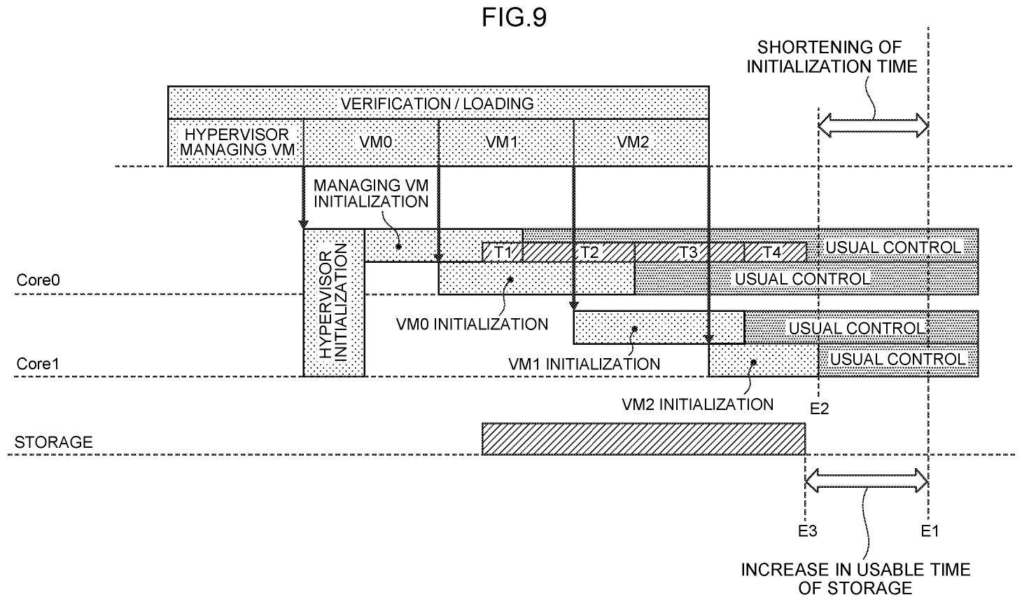

Due to the above-described processings of FIG. 7 and FIG. 8, there is an activation sequence such as shown in FIG. 9. The hatched regions in FIG. 10 are time periods in which the storage 56 is being accessed. Namely, at the time of initialization, the managing VM 18M collectively reads-out the data of the respective VMs 18 from the storage 56, and stores the data in a preset region of the RAM 54. Because the reading time periods T1 through T4 are collected together, increased efficiency of accessing the storage 56 can be realized.

Further, at the time of initialization at each of the VMs 18, the VM 18 acquires the data that was stored in the RAM 54 by the managing VM 18M. The accessing of the RAM 54 is high-speed as compared with the accessing of the storage 56, and therefore, the initialization times of the respective VMs 18 are shortened, and initialization completion time E2 is earlier than the initialization completion time E1 in above-described FIG. 10. Further, as compared with the activation sequence of above-described FIG. 10, access end time E3 of accessing the storage 56 in order to initialize the respective VMs 18 is earlier, and therefore, the usable time of the storage 56 increases. Accordingly, the response time of the storage 56 for usual control or for the initialization of other cores improves. Namely, by improving the efficiency of the initialization times, accessing the storage 56 in other applications is easy.

As described above, in accordance with the central ECU relating to the present embodiment, at the time when the managing VM is activated, the managing VM reads-out the respective data of the plural VMs from the storage and stores the data in the RAM. At the times when the plural VMs are respectively activated, the VM reads-out the data of that VM from the RAM. In this way, when each of the plural VMs other than the managing VM is activated, the VM reads-out the data necessary for activating the VM from the RAM and not from the storage. Accordingly, at the time of activating each of the plural VMs, the time required to activate the VM can be reduced.

Further, the time required for initialization of the VMs is shortened due to the reading-out of the data from the storage, which is a non-volatile memory and becomes a bottleneck, being made efficient.

By eliminating idle times of accessing the storage at the time of initialization, the time at which other domains can access the storage can be advanced, and the usable time of the storage can be increased.

Further, the managing VM reads-out from the storage and stores in the RAM the data of the VMs, in an order corresponding to preset priority levels of the respective VMs. Due thereto, the necessary data can be stored in the RAM in accordance with the priority levels of the respective VMs. Accordingly, the data of the VMs can be read-out from the storage and stored in the RAM in the order in which the VMs are to be activated.

Among the plural VMs, the managing VM is activated first, and the managing VM reads-out the data of the respective VMs from the storage and stores the data in the RAM. Due thereto, even if the respective VMs that are other than the managing VM are activated in parallel, the time required for activation can be reduced.

Note that, although the above embodiment describes an example in which the two CPU cores 14 are provided, the present disclosure is not limited to this. For example, there may be a form in which a single CPU core 14 is provided, or a form in which three or more CPU cores are provided.

Further, although the above embodiment describes an example in which the hypervisor 16 generates the managing VM 18M and the three VMs 18, the present disclosure is not limited to this. For example, the managing VM 18M and three or fewer VMs 18 may be generated, or the managing VM 18M and five or more VMs 18 may be generated.

The above embodiment describes an example of a case in which the vehicle 10 is a vehicle that is driven due to an engine being operated by using gasoline for power, but the present disclosure is not limited to this. The vehicle 10 may be an electric vehicle such as a HEV (Hybrid Electric Vehicle), a PHEV (Plug-in Hybrid Electric Vehicle), a FCEV (Fuel Cell Electric Vehicle), a BEV (Battery Electric Vehicle) or the like.

Moreover, any of various types of processors other than a CPU may execute the various processings that are executed due to the CPU 50 reading-in software (a program) in the above-described embodiment. Examples of processors in this case include PLDs (Programmable Logic Devices) whose circuit structure can be changed after production such as FPGAs (Field-Programmable Gate Arrays) and the like, and dedicated electrical circuits that are processors having circuit structures that are designed for the sole purpose of executing specific processings such as ASICs (Application Specific Integrated Circuits) and the like, and the like. Further, the above-described processings may be executed by one of these various types of processors, or may be executed by a combination of two or more of the same type or different types of processors (e.g., plural FPGAs, or a combination of a CPU and an FPGA, or the like). Further, the hardware structures of these various types of processors are, more specifically, electrical circuits that combine circuit elements such as semiconductor elements and the like.

Further, the above embodiment describes a form in which the program is stored in advance (is installed) on a computer-readable, non-transitory recording medium. For example, the information processing program 60 is stored in advance in the storage 56. However, the present disclosure is not limited to this, and the information processing program 60 may be provided in a form of being recorded on a non-transitory recording medium such as a CD-ROM (Compact Disk Read Only Memory), a DVD-ROM (Digital Versatile Disk Read Only Memory), a USB (Universal Serial Bus) memory or the like. Further, the information processing program 60 may be in a form of being downloaded from an external device via a network.

The flows of the processings described in the above embodiment are examples, and unnecessary steps may be deleted therefrom, new steps may be added thereto, or the order of processings may be rearranged, within a scope that does not depart from the gist of the present disclosure.

What is claimed is:

1. An information processing device comprising:
a non-volatile memory storing, for each of a plurality of virtual machines including a managing virtual machine that manages the plurality of virtual machines, data needed to activate the virtual machine;
a volatile memory; and
a processor coupled to the non-volatile memory and the volatile memory,
wherein the processor is configured to:
generate the plurality of virtual machines,
at a time when the managing virtual machine is activated, read out the respective data of the plurality of virtual machines from the non-volatile memory and store the data in the volatile memory, and
at a time when each virtual machine of the plurality of virtual machines is activated, read out the data of the virtual machine from the volatile memory.

2. The information processing device of claim 1, wherein the managing virtual machine reads out the data of the virtual machines from the non-volatile memory and stores the data in the volatile memory, in an order corresponding to preset priority levels of the respective virtual machines.

3. The information processing device of claim 1, wherein the managing virtual machine is activated first among the plurality of virtual machines.

4. A vehicle comprising the information processing device of claim 1.

5. An information processing method in which a computer performs processing, the computer including:
a non-volatile memory storing, for each of a plurality of virtual machines including a managing virtual machine that manages the plurality of virtual machines, data needed to activate the virtual machine, and
a volatile memory,
the processing comprising:
generating the plurality of virtual machines,
at a time when the managing virtual machine is activated, reading out the respective data of the plurality of virtual machines from the non-volatile memory and storing the data in the volatile memory, and
at a time when each virtual machine of the plurality of virtual machines is activated, reading out the data of the virtual machine from the volatile memory.

6. A non-transitory recording medium on which is recorded a program executable by a computer to perform processing, the computer including:
a non-volatile memory storing, for each of a plurality of virtual machines including a managing virtual machine that manages the plurality of virtual machines, data needed to activate the virtual machine, and
a volatile memory,
the processing comprising:
generating the plurality of virtual machines;
at a time when the managing virtual machine is activated, reading out the respective data of the plurality of virtual machines from the non-volatile memory and storing the data in the volatile memory; and
at a time when each virtual machine of the plurality of virtual machines is activated, reading out the data of the virtual machine from the volatile memory.
